(19) United States
(12) Patent Application Publication
(10) Pub. No.: US 2021/0014074 A1
(43) Pub. Date: Jan. 14, 2021

(54) PRIORITIZE RAISE HAND OPERATION IN A CONFERENCE FOR EFFICIENT AND TIME BOUND CONFERENCE SOLUTION

(71) Applicant: Avaya Inc., Santa Clara, CA (US)

(72) Inventors: Salil Dhawan, Pune (IN); Jibin George, Pune (IN); Sandeep Goynar, Pune (IN); Harsimran Jeet Singh, Pune (IN)

(21) Appl. No.: 16/505,352

(22) Filed: Jul. 8, 2019

(51) Int. Cl. H04L 12/18; H04L 29/06

(52) U.S. Cl. CPC H04L 12/1822; H04L 12/1827; H04L 65/403; H04L 65/1083

(57) ABSTRACT

Electronic conference enables remote participants to obtain conference content from other devices connected as nodes on a network. A presenter may provide all audio content for a portion of the electronic conference and then individuals, associated with nodes on the network, may provide audio content during other portions, such as to ask a question to the presenter or group. Participants may “raise their hand” to request to speak. By automatically unmuting devices associated with requesters in an order different from the order in which the requests were received, devices may be unmuted to receive audio content having a particular importance or relevance to the electronic conference and thereby reduce the time spent on less relevant content.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for communications between nodes on a network and particularly to enabling media-specific channels of selected nodes.

### BACKGROUND

Electronic conferences are a common way that geographically diverse users may participate in a live meeting. Conferences may have a lecture format, where a presenter solely provides the majority of the content. Conferences may also invite participants to contribute to the content of the conference, such as to ask questions of the presenter or other participants.

### SUMMARY

Electronic conferences of the prior art are routine occurrences in many commercial or academic settings. Individuals may participate in an electronic conference to view a particular speaker or topic of interest. The presentation of conference content may be by an individual or group of individuals. Often a presenter will accept conference content from participants, such as when a participant wishes to ask a question. When a participant wishes to ask a question, they will provide an input to the communication device utilized for the conference. This is known as a “raise hand” to resemble the physical act of raising one's hand in classroom or other on-site meeting, but in the electronic conference. Prior art systems utilize a first-in-first-out (FIFO) queuing system, whereby the first participant to raise their hand will be the first participant called upon to ask their question. However, FIFO queuing fails to consider the relevance or importance of a particular question or participant asking the question. Time available for a presentation, and more specifically, time available for participants to ask questions is limited. Time available may be limited by a scheduling limitation (e.g., the presenter or presentation equipment may be unavailable at a certain time) or the value of the electronic conference may diminish as additional time may be provided to address participants questions, but other participants may not be available for an extended time and drop-off the electronic conference. Therefore, there is a need to allow participants to ask questions in an order determined, not determined by the order the “raise hand” signal was received, but by the importance and/or relevance of an attribute of the question and/or the participant asking the question.

These and other needs are addressed by the various embodiments and configurations of the present invention. The present invention can provide a number of advantages depending on the particular configuration. These and other advantages will be apparent from the disclosure of the invention(s) contained herein. Such as to allow a fixed time for participant contribution, such as to ask questions, to be utilized for the most important and/or relevant issues so that if the fixed time expires, it is the less important and/or relevant topics and issues that are omitted.

In one embodiment, a system is disclosed, comprising: a system for automatically unmuting nodes communicating over a network, comprising: a presenter node and a plurality of participant nodes engaged in an electronic conference via the network and each of the presenter node and the plurality of participant nodes comprising a network interface to the network and receiving audio content of the electronic conference; a processor having instructions to selectively mute and unmute audio content originating from any one or more of the plurality of participant nodes for selective exclusion or inclusion in the electronic conference; and wherein the presenter node, when in a lecture mode, provides audio content for the electronic conference and the plurality of participant nodes being muted; wherein the processor receives a hand-raise signal from at least two requesting nodes, of the plurality of participation nodes, wherein the hand-raise signal indicates a request by an associated one of the at least two requesting nodes, to be unmuted; wherein the processor prioritizes the order in which the at least two of the plurality of participant nodes will be unmuted based on a priority criterion that weights an attribute of at least one of a) a user associated with one of the at least two requesting nodes or b) a topic of the electronic conference and wherein the priority criterion is devoid of any relative order in which the hand-raise signals are received.

In another embodiment, a method for selective unmuting of nodes communicating over a network is disclosed, comprising: engaging a presenter node and a plurality of participant nodes in an electronic conference via the network and each of the presenter node and the plurality of participant nodes receiving audio content of the electronic conference; selectively muting and unmuting, by a processor, audio content originating from any one or more of the plurality of participant nodes for selective exclusion or inclusion in the electronic conference; providing audio content for the electronic conference and the plurality of participant nodes being muted, by the presenter node, when in a lecture mode; receiving, by the processor, a hand-raise signal from at least two requesting nodes, of the plurality of participation nodes, wherein the hand-raise signal indicates a request by an associated one of the at least two requesting nodes, to be unmuted; and prioritizing, by the processor, the order in which the at least two of the plurality of participant nodes will be unmuted based on a priority criterion that weights an attribute of at least one of a) a user associated with one of the at least two requesting nodes or b) a topic of the electronic conference and wherein the priority criterion is devoid of any relative order in which the hand-raise signals are received.

In another embodiment, a system for automatically unmuting nodes communicating over a network is disclosed, comprising: means to engaging a presenter node and a plurality of participant nodes in an electronic conference via the network and each of the presenter node and the plurality of participant nodes receiving audio content of the electronic conference; means to selectively muting and unmuting audio content originating from any one or more of the plurality of participant nodes for selective exclusion or inclusion in the electronic conference; means to provide audio content for the electronic conference and the plurality of participant nodes being muted, by the presenter node, when in a lecture mode; means to receive a hand-raise signal from at least two requesting nodes, of the plurality of participation nodes, wherein the hand-raise signal indicates a request by an associated one of the at least two requesting nodes, to be unmuted; means to prioritize, the order in which the at least two of the plurality of participant nodes will be unmuted based on a priority criterion that weights an attribute of at least one of a) a user associated with one of the at least two requesting nodes or b) a topic of the electronic conference and wherein the priority criterion is devoid of any relative order in which the hand-raise signals are received; means to unmute one of the requesting nodes having the highest priority of the at least two requesting nodes, upon receiving a signal from the presenter node, the signal indicating at least one of lecture mode has ended or audio from the plurality of participant nodes will be accepted.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a first data structure in accordance with embodiments of the present disclosure;

FIG. 3 depicts a second data structure in accordance with embodiments of the present disclosure;

FIG. 4 depicts a third data structure in accordance with embodiments of the present disclosure;

FIG. 5 depicts a fourth data structure in accordance with embodiments of the present disclosure;

FIG. 6 depicts a fifth data structure in accordance with embodiments of the present disclosure;

FIG. 7 depicts a sixth data structure in accordance with embodiments of the present disclosure;

FIGS. 8A-B depict a process in accordance with embodiments of the present disclosure; and

FIG. 9 depicts a communication device in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

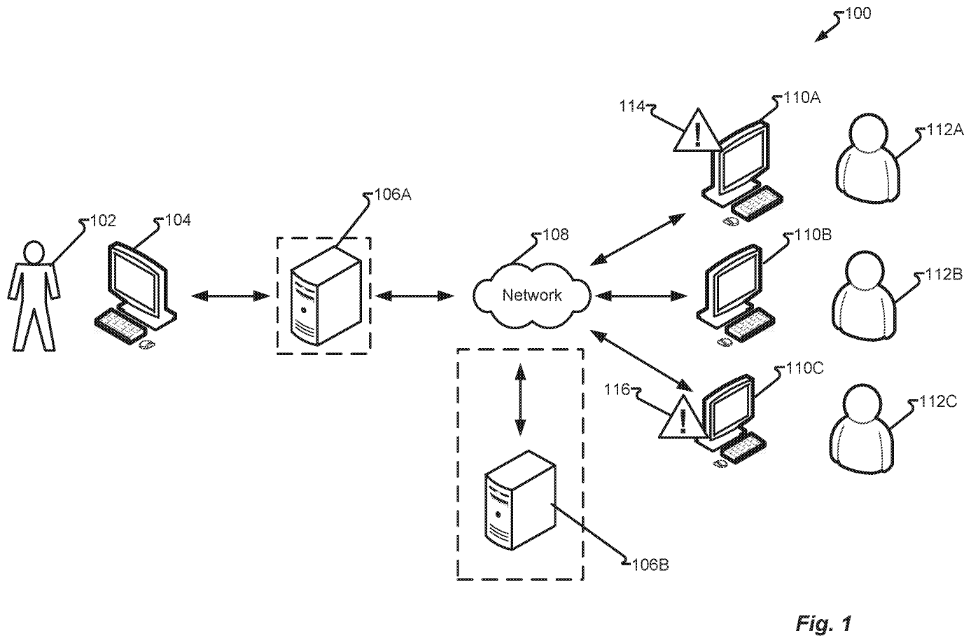

FIG. 1 depicts system 100 in accordance with embodiments of the present disclosure. In one embodiment, an electronic conference is underway comprise a plurality of nodes interconnected via network 108. One of the nodes, presenter node 104 is utilized by presenter 102 to present conference content to each of participant nodes 110 utilized by respective ones of participants 112. It should be appreciated that other network topologies may be utilized without departing from the embodiments disclosed herein. For example, conferencing application may be executed by a processor of server 106. Server 106A may be utilized as a gateway device to network 108 by presenter node 104. In another embodiment, server 106B is a node attached to network 108. The processor executing the conferencing application may also be co-located with presenter node 104. The conferencing application executed by the processor may providing conferencing services such as, allowing authorized participants 112 to receive the conference content via their respective participant node 110, roll call, floor control, muting/unmuting, agenda management, document management, etc.

Presenter node 104 and participant nodes 110 are illustrated as computers, such as devices having a network interface to network 108 directly or, in one embodiment of presenter node 104, via server 106A, to receive and optionally provide content of the electronic conference. Nodes utilized, including presenter node 104 and/or one or more of participant nodes 110 may support multimedia content (e.g., audio, audio/video, images, data, etc.) or, in other embodiments, at least one node may support or be configured to receive or present less than all media types, such as an audio only device (e.g., digital or analog telephone) or a text only device (e.g., simple messaging system (SMS), chat application of a personal computer/cellular telephone). The content provided may be comprise text, video, audio, co-browsing, static images, recorded content, and/or other content. participant nodes 110 unable to receive a particular channel, such as if a particular one of participant nodes 110 is configured to receive audio only, the video content may be omitted.

During the electronic conference, each of participant nodes 110 are muted or otherwise silenced preventing any of participant nodes 110 from providing content to the electronic conference. For example, when the electronic conference comprises audio, each of participant nodes 110 may be muted until such time as they may be selected to ask a question. Similarly, if the electronic conference comprises text, the text input by any participants 112 to their respective participant nodes 110 may be silenced such that ether no text is received or, if the text is received, it is not included for presentation to any other participant nodes 110 or presenter node 104. Participants 112 may wish to provide content, such as to be unmuted (or otherwise unsilenced) to ask a question of presenter 102 or other participants 112.

The electronic conference may have a lecture mode, wherein presenter 102 via presenter node 104 provides the content of the electronic conference, similar to that of a lecture or classroom. When the lecture mode ends, such as at a previously determined time, by marking preceding agenda items as complete, or by receiving a signal at the processor executing the conferencing application that the lecture mode has terminated, selected participant node 110 may be unmuted to allow their respective participant 112 to provide content. The termination of lecture mode may be indicated by entry into a different mode, such an audience participation mode.

In another embodiment, participant 112A wishes to contribute content to the electronic conference, such as to ask a question of presenter 102. Accordingly, participant 112A provides an input to participant node 110A that causes participant node 110 to send a “raise hand” signal to a processor executing instructions of a conference application, such as a processor of server 106. If participant 112A is the only party to have raised their hand, then when lecture mode has ended, the processor will unmute participant node 110A and thereby allow participant 112A to ask their question. However, if two or more participants 112, such as participant 112A and participant 112C, cause participant node 110A and participant node 110C to issue a “raise hand” signal, such as raise hand signal 114 and raise hand signal 116, respectively, then a prioritization algorithm is executed to determine which one of participant node 110A or 110C will be unmuted first when lecture mode has ended. As can be appreciated, the embodiments herein may be applied to any plurality of participant nodes 110 and any plurality of such nodes issuing a “raise hand” signal.

As will be described more completely in the embodiments that follow, the prioritization of the presentation nodes 110 to unmute is variously embodied. Prioritization is indifferent to the time or order in which the “raise hand” signals were received. Generally, prioritization is executed as an algorithm to identify the most relevant or the most important questions to accept for inclusion into the content of the electronic conference. In one embodiment, certain question topics may be associated with a particular position in a series of agenda items. For example, presenter 102 may have seven agenda items to discuss and only want to accept questions after presenter 102 has completed presenting that particular agenda item. If raise hand signal 114 is associated with agenda item four, then upon completion of agenda item three, participant node 110 may remain muted, even if lecture mode has ended. Presenter 102 may reinitiate lecture mode and present the fourth agenda item. Upon completion of the fourth agenda item the lecture mode may again be terminated, whereby participant node 110A is unmuted to allow the question, relevant to the fourth agenda item, to be asked. Unmuting may be automatically provided, such as by receiving a signal from server 106 at participant node 110A. As a result, human intervention is omitted to unmute the participant node associated with the next highest priority question or other content. In other embodiments, priority may be determined by a role or other attribute associated with the particular participant 112 and their associated participant node 110.

For example, participant 112C may be an executive of the company having the electronic conference or a specialist with particular knowledge of a relevant topic. Accordingly, upon receipt of hand raise signal 116, prioritization may be given to unmute participant node 110C over other participant nodes 110. A processor, such as one associated with server 106 and/or presenter node 104 may utilize an algorithm with data, such as in the form of one or more data structures, in determining the priority.

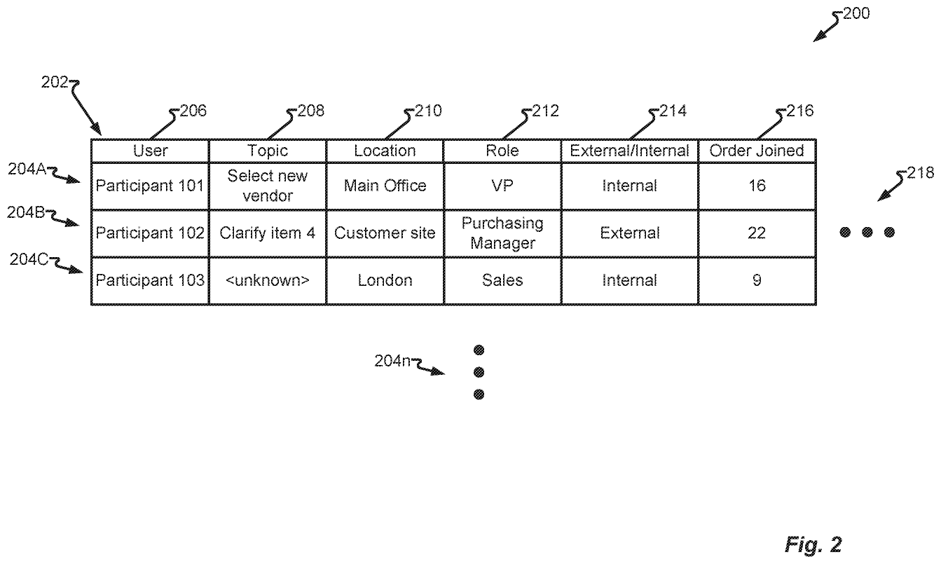

FIG. 2 depicts data structure 200 in accordance with embodiments of the present disclosure. In one embodiment, a processor, such as a processor associated with server 106 prioritizes participant nodes 110 that have provided a “raise hand” signal, such as raise hand signal 114 and raise hand signal 116 (see FIG. 1). Data structure 200 comprises a number of fields 202 for records 204 (indicated as records 204A-204n), such as one for each participant identified in user identifier field 206. Fields 202 are variously embodied and may include one or more of user identifier field 206, topic field 208 of a question associated with “raise hand” signal, location field 210, role field 212, external/internal field 214, order joined field 216, and as indicated by ellipsis 218 other fields that may be utilized for a particular electronic conference or to suit an organization or individual's needs.

Location field 210 may be a geographical location, office location, site identifier, or other relevant location. etc.). Role field 212 may be a role associated with a particular project, rank, job title, etc. External/internal 214 field may be an indication if a particular participant is within, or not within, a particular organization. Order joined field 216 may be the order in which participants joined the electronic conference, such as to give a greater (or lessor) priority to those who have been on longer than those who have more recently joined (or vice versa).

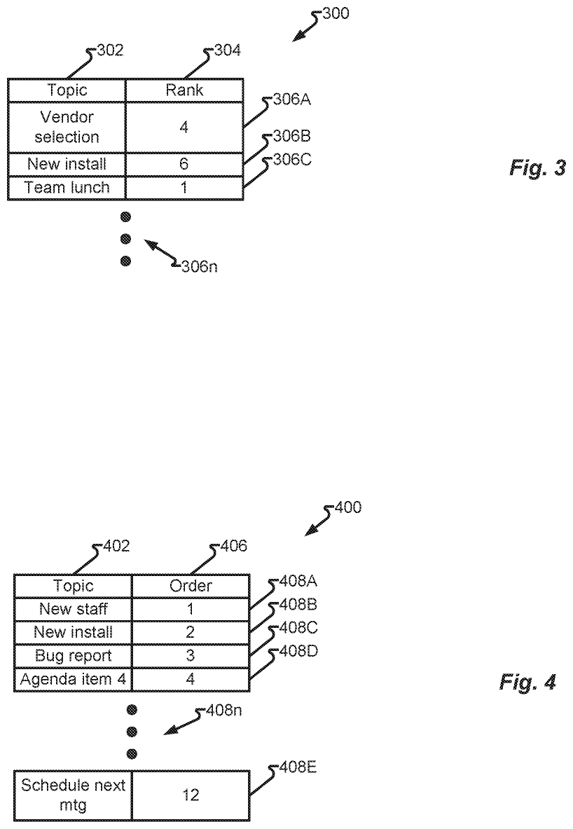

FIG. 3 depicts data structure 300 in accordance with embodiments of the present disclosure. In one embodiment, a processor, such as a processor associated with server 106 prioritizes participant nodes 110 that have provided a “raise hand” signal, such as raise hand signal 114 and raise hand signal 116 (see FIG. 1). Data structure 300 comprises at least a topic field 302 and a rank field 304. Data structure 300 comprises a number of records 306 (indicated as records 306A-306n). Prioritization may then be based, alone or in part, on a particular priority ranking, indicated by rank field 304, for an associated topic, indicated by topic field 302.

FIG. 4 depicts data structure 400 in accordance with embodiments of the present disclosure. In one embodiment, a processor, such as a processor associated with server 106 prioritizes participant nodes 110 that have provided a “raise hand” signal, such as raise hand signal 114 and raise hand signal 116 (see FIG. 1). Data structure 400 comprises topic field 402 and order field 406, such as to indicate a particular position within an electronic conference that a particular topic will, or will not, allow questions or other content from participants 112.

In one embodiment, a processor may be executing a conferencing application that also comprises agenda management. A provided agenda is then addressed item by item and upon an indication that an agenda item has been sufficiently addressed, either by the time allocated for that particular agenda item expiring or by receiving a signal, such as from presenter node 104, that the item has been completed. A “raise hand” signal associated with a particular agenda item may be handled at a particular position within the electronic conference. For example, questions may be handled immediate followed presentation of a particular topic or at the end, such as to follow the agenda of items presented and, once completely, receive questions in the same order as those of the associated agenda items. For example, questions received to discuss a “bug report” may be accepted by unmuting the particular participant node 110 associated with a “raise hand” signal and further indicating the topic (e.g., “bug report”), may be limited to only the time period “3” (see, record 408C). If the current agenda being discussed is, for example, “new staff” (see record 408A) then even with lecture mode suspended, the question may be deferred until item “3” is current and available for questions.

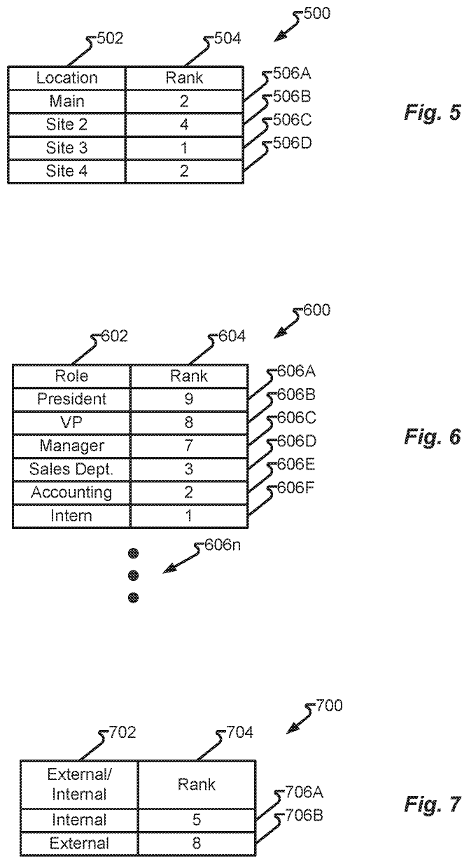

FIG. 5 depicts data structure 500 in accordance with embodiments of the present disclosure. In one embodiment, a processor, such as a processor associated with server 106 prioritizes participant nodes 110 that have provided a “raise hand” signal, such as raise hand signal 114 and raise hand signal 116 (see FIG. 1). Data structure 500 comprises location field 502 and rank 504 and a number of records, indicated as records 506A-506D. A certain location may have an importance or relevance to a particular electronic conference or item of discussion within the electronic conference. For example, record 506C may be associated with “site 3” which may have a particular relevance or importance for an electronic conference, such that participants at that location may be prioritized over participants from other locations.

FIG. 6 depicts data structure 600 in accordance with embodiments of the present disclosure. In one embodiment, a processor, such as a processor associated with server 106 prioritizes participant nodes 110 that have provided a “raise hand” signal, such as raise hand signal 114 and raise hand signal 116 (see FIG. 1). Data structure 600 comprises role field 602 and rank 604 and a number of records, indicated as records 606A-606n. In one embodiment, importance or relevance may be inferred from the role of an individual associated with a particular “raise hand” signal. A role may be a job title, department, assignment, or other function associated with a participant.

FIG. 7 depicts a data structure 700 in accordance with embodiments of the present disclosure. In one embodiment, a processor, such as a processor associated with server 106 prioritizes participant nodes 110 that have provided a “raise hand” signal, such as raise hand signal 114 and raise hand signal 116 (see FIG. 1). Data structure 700 comprises internal/external field 702 and rank field 704. Data structure 700 may be utilized to indicate whether a participant associated with a particular “hand raise” signal is within, or not within, a particular organization. Rank may be binary (e.g., “0” or “1”) such as if the only factor considered or, as will be discussed more completely with respect to process 800, weighted. For example, an intern of a vendor may be scored as an “8” (see record 7096B and FIG. 6, record 606F) whereas a member of the company's accounting team scored as a “7” (see record 706A and FIG. 6, record 606E). In the foregoing example, an overall ranking was the result of adding individual ranks associated with participant and “hand raised” signal. Other combinations (e.g., multiplication, exponential, enumerated, etc.) of individual rankings may be utilized without departing from the scope of the embodiments provided herein.

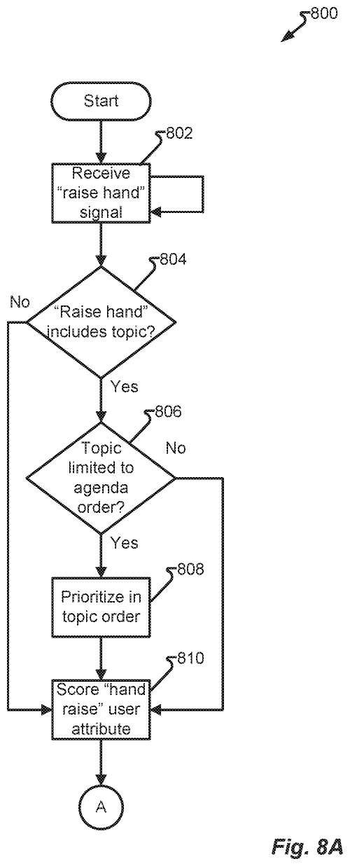

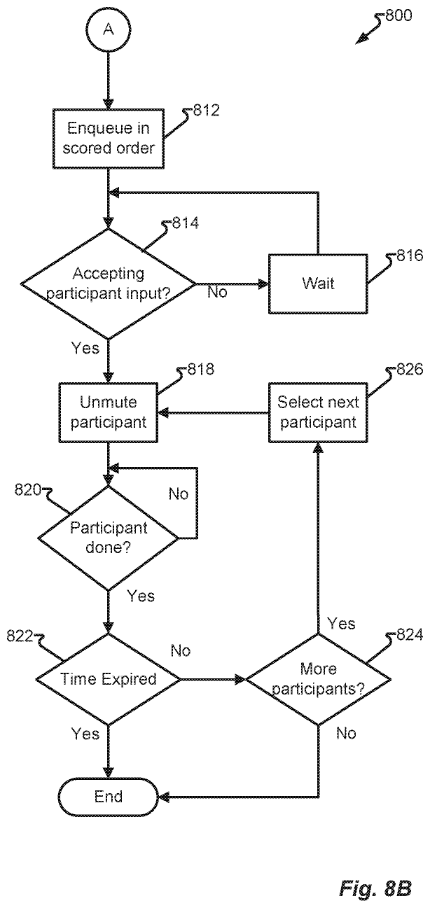

FIGS. 8A-B depict process 800 in accordance with embodiments of the present disclosure. Process 800 may be executed, when converted into machine-executable instructions, by a processor, such as a processor executing a conferencing application on server 106, presenter node 104, or other device operable to prioritize participant nodes 110 having providing (or polled) a “raise hand” signal and cause ones of participant node 110 selected to be unmuted to provide content to an electronic conference.

In one embodiment, process 800 begins and, in step 802, receives a “raise hand” signal from one of participant nodes 110. Step 802 may be executed periodically or continual and such execution may be independent of the reminder of process 800 such as to continually allow new “raise hand” signals to be received. Test 804 determines if a determinative attribute is provided. For example, a priority may be determined solely based on a topic associated with the “raise hand” signal. For example, participant 112A may cause “raise hand” signal 114 to be sent along with a topic. The topic may be explicitly stated (e.g., “sales projections”) or extracted utilizing natural language processor from a freeform statement (e.g., “I have a question on the sales projections for next year.”). A determinative test, such as test 804 may override other factors in terms of prioritization. For example, test 806 may determine if the topic is limited to a particular agenda order. A topic related to a future or past agenda item may be deprioritized over topics associated with a current agenda item. If test 804 determines that a topic is provided and test 806 determines that the topics are limited to agenda order, then step 808 prioritizes the “raise hand” signals in agenda order. Within the agenda order provided by test 806, scoring of the “raise hand” attributes may be provided in step 810.

In another embodiment, either no determinative test is utilized or, if utilized, determined in the negative, such as test 804 determined in the negative. Step 810 then scores the “raise hand” attributes with respect to the question or the participant asking the question, for example, considering one or more of data values within a field of data structure 200, 300, 400, 500, 600, and/or 700 (see, FIGS. 2-7). Next, step 812 enqueues the participants in priority order. Test 814 determines if participant input into the electronic conference, such as when lecture mode has been terminated or suspended to enable participants 112 to ask a question or otherwise contribute content, is being accepted. If test 814 is determined in the negative, step 816 may wait a period of time or for the occurrence of an event (e.g., signal indicating completion of an agenda item, signal from presenter node 104 indicating that questions will be accepted, etc.) and return to test 814. If test 814 is determined in the affirmative, the highest priority participant nodes 110, having sent a “raise hand” signal, is unmuted to enable the associated participant 112 to ask their question. Test 820 determines if the participant is done and, if no, may loop back to itself. Upon test 820 being determined in the affirmative, test 822 may determine if the time for questions from participant has expired and, if determined in the negative, proceed to test 824. If test 822 is determined in the affirmative, process 800 may end, such as by returning to lecture mode or terminating the electronic conference. If test 822 and test 824 are determined in the negative, then process 800 may end. However, if test 824 is determined in the affirmative, then processing may continue to step 826 to select the next highest priority participant to unmute in step 818.

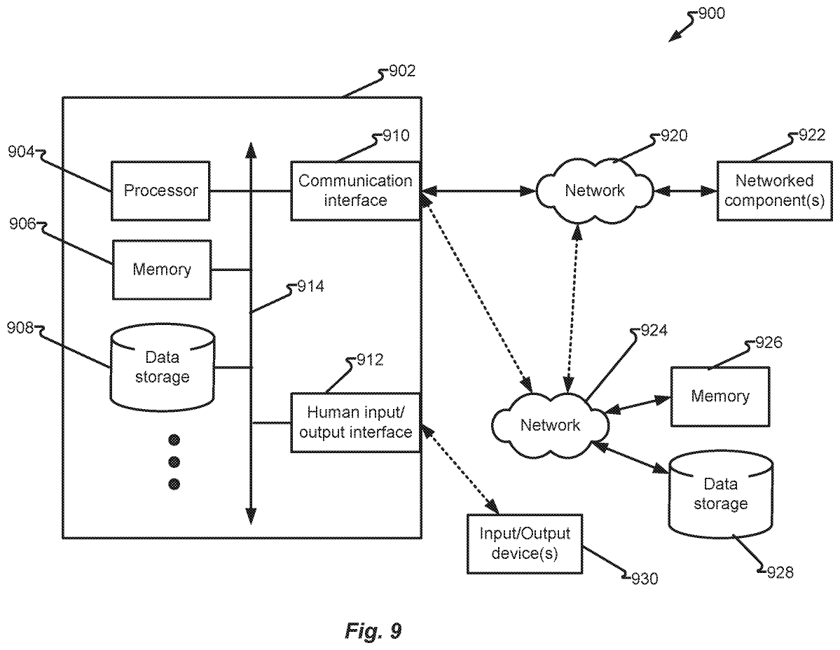

FIG. 9 depicts device 902 in system 900 in accordance with embodiments of the present disclosure. In one embodiment, one or more of presenter node 104, server 106, participant nodes 110 may be embodied, in whole or in part, as device 902 comprising various components and connections to other components and/or systems. The components are variously embodied and may comprise processor 904. Processor 904 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 914, executes instructions, and outputs data, again such as via bus 914.

In addition to the components of processor 904, device 902 may utilize memory 906 and/or data storage 908 for the storage of accessible data, such as instructions, values, etc. Communication interface 910 facilitates communication with components, such as processor 904 via bus 914 with components not accessible via bus 914. Additionally or alternatively, input/output interface 912 connects to one or more interface components to receive and/or present information (e.g., instructions, data, values, etc.) to and/or from a human and/or electronic device. Examples of input/output devices 930 that may be connected to input/output interface include, but are not limited to, keyboard, mouse, trackball, printers, displays, sensor, switch, relay, etc. In another embodiment, communication interface 910 may comprise, or be comprised by, input/output interface 912. Communication interface 910 may be configured to communicate directly with a networked component or utilize one or more networks, such as network 920 and/or network 924.

Network 108 may be embodied, in whole or in part, as network 920. Network 920 may be a wired network (e.g., Ethernet), wireless (e.g., WiFi, Bluetooth, cellular, etc.) network, or combination thereof and enable device 902 to communicate with network component(s) 922.

Additionally or alternatively, one or more other networks may be utilized. For example, network 924 may represent a second network, which may facilitate communication with components utilized by device 902. For example, network 924 may be an internal network to an organization or business whereby components are trusted (or at least more so) that networked components 922, which may be connected to network 920 comprising a public network (e.g., Internet) that may not be as trusted. Components attached to network 924 may include memory 926, data storage 928, input/output device(s) 930, and/or other components that may be accessible to processor 904. For example, memory 926 and/or data storage 928 may supplement or supplant memory 906 and/or data storage 908 entirely or for a particular task or purpose. For example, memory 926 and/or data storage 928 may be an external data repository (e.g., server farm, array, “cloud,” etc.) and allow device 902, and/or other devices, to access data thereon. Similarly, input/output device(s) 930 may be accessed by processor 904 via input/output interface 912 and/or via communication interface 910 either directly, via network 924, via network 920 alone (not shown), or via networks 924 and 920.

It should be appreciated that computer readable data may be sent, received, stored, processed, and presented by a variety of components. It should also be appreciated that components illustrated may control other components, whether illustrated herein or otherwise. For example, one input/output device 930 may be a router, switch, port, or other communication component such that a particular output of processor 904 enables (or disables) input/output device 930, which may be associated with network 920 and/or network 924, to allow (or disallow) communications between two or more nodes on network 920 and/or network 924. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for automatically unmuting nodes communicating over a network, comprising:
a presenter node and a plurality of participant nodes engaged in an electronic conference via the network and each of the presenter node and the plurality of participant nodes comprising a network interface to the network and receiving audio content of the electronic conference;
a processor having instructions to selectively mute and unmute audio content originating from any one or more of the plurality of participant nodes for selective exclusion or inclusion in the electronic conference;
wherein the presenter node, when in a lecture mode, provides audio content for the electronic conference and the plurality of participant nodes being muted;
wherein the processor receives a hand-raise signal from at least two requesting nodes, of the plurality of participant nodes, wherein the hand-raise signal indicates a request by an associated one of the at least two requesting nodes, to be unmuted; and
wherein the processor prioritizes an order in which the at least two of the plurality of participant nodes will be unmuted based on a priority criterion that weights an attribute of at least one of a) a user associated with one of the at least two requesting nodes or b) a topic of the electronic conference and wherein the priority criterion is devoid of any relative order in which the hand-raise signals are received.

2. The system of claim 1, wherein the processor, upon receiving a signal from the presenter node that lecture mode has ended, unmutes one of the at least two requesting nodes having the highest priority of the at least two requesting nodes.

3. The system of claim 1, wherein the processor, upon receiving a signal to accept audio from the plurality of participant nodes, unmutes one of the at least two requesting nodes having the highest priority of the at least two requesting nodes.

4. The system of claim 1, wherein the attribute comprises a role of the user associated with one of the at least two requesting nodes.

5. The system of claim 1, wherein the attribute comprises the order in which the at least two requesting nodes joined the electronic conference.

6. The system of claim 1, wherein the attribute comprises a location of the user associated with one of the at least two requesting nodes.

7. The system of claim 1, wherein the hand-raise signal further comprises a subject matter and the attribute comprises a match between the topic of the electronic conference and the subject matter.

8. The system of claim 1, wherein the hand-raise signal further comprises a subject matter and the attribute comprises a match between a current topic of the electronic conference and the subject matter.

9. The system of claim 1, wherein the hand-raise signal further comprises a subject matter and the attribute comprises a match between the order of subject matter of the electronic conference.

10. The system of claim 1, wherein the attribute comprises a weight of one priority criterion, associated with a first of the at least two requesting nodes, and the weight of a second priority criterion, associated with a second of the at least two requesting nodes.

11. A method, for selective unmuting of nodes communicating over a network, comprising:
engaging a presenter node and a plurality of participant nodes in an electronic conference via the network and each of the presenter node and the plurality of participant nodes receiving audio content of the electronic conference;
selectively muting and unmuting, by a processor, audio content originating from any one or more of the plurality of participant nodes for selective exclusion or inclusion in the electronic conference;
providing audio content for the electronic conference and the plurality of participant nodes being muted, by the presenter node, when in a lecture mode;
receiving, by the processor, a hand-raise signal from at least two requesting nodes, of the plurality of participant nodes, wherein the hand-raise signal indicates a request by an associated one of the at least two requesting nodes, to be unmuted; and
prioritizing, by the processor, an order in which the at least two of the plurality of participant nodes will be unmuted based on a priority criterion that weights an attribute of at least one of a) a user associated with one of the at least two requesting nodes or b) a topic of the electronic conference and wherein the priority criterion is devoid of any relative order in which the hand-raise signals are received.

12. The method of claim 11, further comprising unmuting one of the at least two requesting nodes having the highest priority of the at least two requesting nodes, upon receiving, by the processor, a signal from the presenter node that lecture mode has ended.

13. The method of claim 11, further comprising unmuting one of the at least two requesting nodes having the highest priority of the at least two requesting nodes, upon receiving, by the processor, a signal to accept audio from the plurality of participant nodes.

14. The method of claim 11, wherein the attribute comprises a role of the user associated with one of the at least two requesting nodes.

15. The method of claim 11, wherein the attribute comprises the order in which the at least two requesting nodes joined the electronic conference.

16. The method of claim 11, wherein the attribute comprises a location of the user associated with one of the at least two requesting nodes.

17. The method of claim 11, wherein the hand-raise signal further comprises a subject matter and the attribute comprises a match between the topic of the electronic conference and the subject matter.

18. The method of claim 11, wherein the hand-raise signal further comprises a subject matter and the attribute comprises at least one of a match between (a) a current topic of the electronic conference and the subject matter and (b) an order of subject matter of the electronic conference and the subject matter.

19. The method of claim 11, wherein the attribute comprises a weight of one priority criterion, associated with a first of the at least two requesting nodes, and the weight of a second priority criterion, associated with a second of the at least two requesting nodes.

20. A system for automatically unmuting nodes communicating over a network, comprising:
means to engaging a presenter node and a plurality of participant nodes in an electronic conference via the network and each of the presenter node and the plurality of participant nodes receiving audio content of the electronic conference;
means to selectively muting and unmuting audio content originating from any one or more of the plurality of participant nodes for selective exclusion or inclusion in the electronic conference;
means to provide audio content for the electronic conference and the plurality of participant nodes being muted, by the presenter node, when in a lecture mode;
means to receive a hand-raise signal from at least two requesting nodes, of the plurality of participant nodes, wherein the hand-raise signal indicates a request by an associated one of the at least two requesting nodes, to be unmuted;
means to prioritize an order in which the at least two of the plurality of participant nodes will be unmuted based on a priority criterion that weights an attribute of at least one of a) a user associated with one of the at least two requesting nodes orb) a topic of the electronic conference and wherein the priority criterion is devoid of any relative order in which the hand-raise signals are received; and
means to unmute one of the requesting nodes having the highest priority of the at least two requesting nodes, upon receiving a signal from the presenter node, the signal indicating at least one of the lecture modes has ended or audio from the plurality of participant nodes will be accepted.
